(19) United States
(12) Patent Application Publication
(10) Pub. No.: US 2004/0048512 A1
(43) Pub. Date: Mar. 11, 2004

(54) QUICK COUPLER FOR CYLINDRICAL BATTERY TERMINAL

(76) Inventor: Carl Chen, Tao Yuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/238,645

(22) Filed: Sep. 11, 2002

(51) Int. Cl. H01R 3/00

(52) U.S. Cl. 439/500

(57) ABSTRACT

A quick coupler for connecting power from a wire to a cylindrical terminal of a battery includes an insulted mask having a top plate, a cylindrical wall and an open end forming an internal cavity. A metal disk and a plurality of elastic metal strips are mounted in the internal cavity. The elastic metal strips are downward extended from a periphery of the metal disk and spaced from each other. The lower section of each elastic metal strip is formed with an outward inclined section which is engaged with an inward edge formed on the interior surface at the open end of the cylindrical wall of the insulated mask. The interior surface wall of each elastic metal strip is formed with a plurality of transverse ribs for enhancing contact with the cylindrical terminal of the battery.

### BACKGROUND OF THE INVENTION

1. Field of the Invention

The present invention generally relates to a connector for battery terminal, and in particular to a quick coupler for connecting cylindrical battery terminal of a battery set.

2. Description of the Prior Art

Batteries are widely used in vehicle, ship, electric motor, uninterrupted power system, portable electronic equipment and so on. The terminal of the known Pb-acid battery is either in a L-shaped or cylindrical form. The cylindrical battery terminal is mostly used in a battery with larger electric power capacity, while the L-shaped terminal is used in a battery with smaller electric power capacity.

FIG. 1 shows a perspective view of a prior art battery 1 mounted with two conventional cylindrical terminals thereon. The cylindrical terminals include a positive terminal 2 and a negative terminal 3 upward extended from the battery 1.

In the manufacture of the battery, lead oxide is mixed with sulfuric acid to form into paste, which can be smoothly coated on the battery grid. After curing, the battery grid is fitted into battery case with two protruded ends. After the assembly of the electric plate and the battery case, it is followed by an important procedure known as “formation”. During formation, the two protruded ends are connected respectively to two wires, and electrified. Under controlled conditions of appropriate electric current, electric voltage, time, specific gravity of acid, paste coated on the plate is transferred by electrical chemistry into the positive and negative terminals.

In prior art, for connection of battery terminals to wires, a metal ring is put around the cylindrical terminal of the battery and then fastened by means of a fixing screw. In another connection approach, alligator clips 4 are used to clip on the cylindrical terminal, so as to connecting a wire 5 to the terminal of the battery, as shown in FIG. 1. In practice, connection of terminals of the battery is always needed for purposes like charging, discharging or measurement of electricity.

However, in the application of conventional metal ring for wire connection, it wastes a lot of time and effort in fastening the screw, which does not meet production requirement. The use of alligator clips is not ideal too. It is because the sharp teeth and strong clipping power of alligator clip always cause damage to metal surface of battery terminal. Hence, some batteries will become defect. Moreover, when electricity is connected, electric flow is mainly via the sharp tooth tips of alligator clip, where conductivity is poor. Although alligator clip is more convenient and improved as compared to conventional screw, it is not effective enough for saving of time and effort in the viewpoint of manufacturers. During formation of battery, since a batch of batteries will be connected, it wastes a lot of effort. In addition, alligator clip is not safe and workers may carelessly touch the conductive part of clip and be shocked during operation.

Thus, it is desired to have a quick coupler for cylindrical battery terminal for overcoming the problems discussed above.

### SUMMARY OF THE INVENTION

Accordingly, a primary object of the present invention is to provide a quick coupler for cylindrical battery terminal. The connection between the electric wire and the battery terminal can be simplified and accomplished in short time by mounting the quick coupler onto the battery terminal.

Another object of the present invention is to provide a good conductive coupler for cylindrical battery terminal. When mounted to the battery terminal, by means of the ring shape contact surface, the coupler can tightly contact the metal part of battery terminal, providing excellent conductivity between battery terminal and wire.

Another object of the present invention is to provide a smooth coupler for cylindrical battery terminal, which can avoid damage to battery terminal. Since there is no sharp teeth on the coupler, it will not cause damage to the surface of battery terminal.

A further object of the present invention is to provide an electric safe coupler for cylindrical battery terminal. The coupler is easily to be mounted on battery terminal and greatly reduces the chance of careless touching of conductive part by workers. Unlike the alligator clip, the ring shape coupler processes no teeth, and hence will not generate electric arc. Safety and coupler life-span is greatly enhanced

### BRIEF DESCRIPTION OF THE DRAWINGS

The present invention will be apparent to those skilled in the art by reading the following description of preferred embodiments thereof, with reference to the accompanying drawings, in which:

FIG. 1 is a perspective view showing a pair of clips may clip on the cylindrical terminals of a battery in accordance the prior art;

FIG. 2 is a perspective view showing a pair of quick couplers constructed in accordance with a preferred embodiment of the present invention may be mounted on the cylindrical battery terminals of a battery;

FIG. 3 is a bottom perspective view of the quick coupler of the present invention;

FIG. 4 shows that the quick coupler of the present invention includes a metal disk and a plurality of elastic metal strips;

FIG. 5 is a cross-sectional view of the quick coupler of the present invention taken along line 5-5 of FIG. 3;

FIG. 6 shows that the interior surface wall of the elastic metal strip of the present invention is formed with a plurality of transverse ribs; and

FIG. 7 is a cross-sectional view showing that the elastic metal strip of the present invention is further formed with a bent section between the metal disk and the terminal contact section.

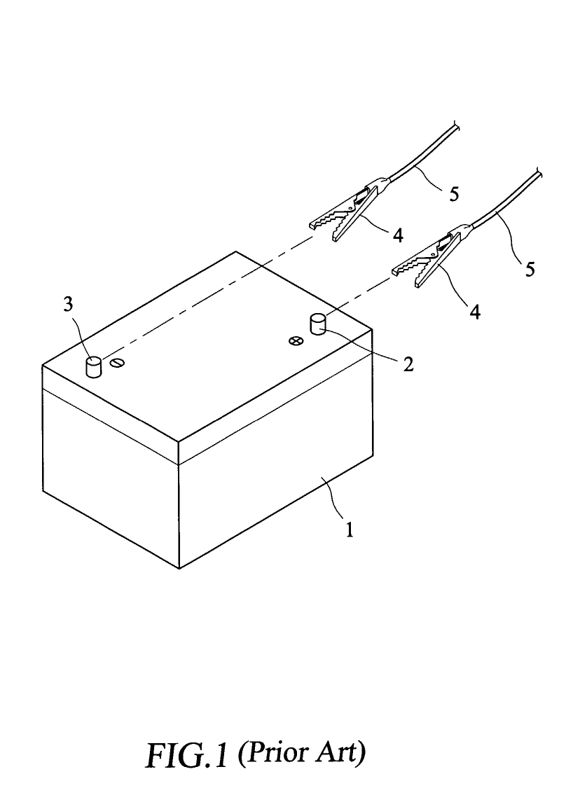

### DETAILED DESCRIPTION OF THE PREFERRED EMBODIMENTS

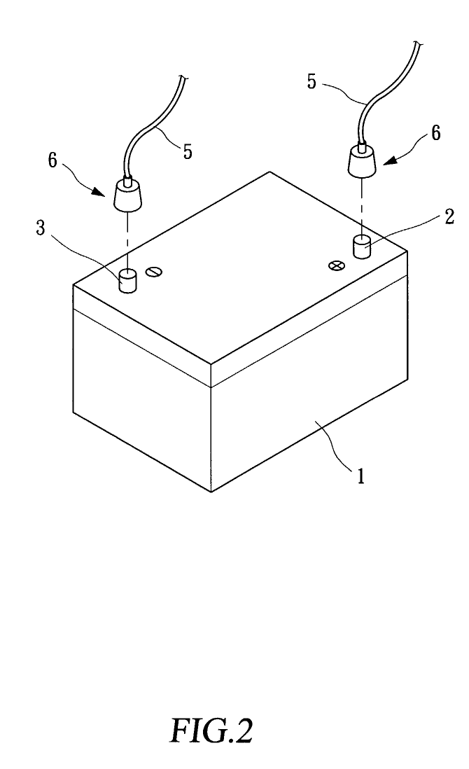

With reference to FIG. 2, it is a perspective view showing that a pair of quick couplers 6 constructed in accordance with a preferred embodiment of the present invention is mounted on the cylindrical battery terminals 2, 3 respectively formed on a battery 1. For explanation, the same reference numbers used in the previous drawing will be used to refer to the same or like parts. Each of the quick couplers 6 is connected with an electric wire 5.

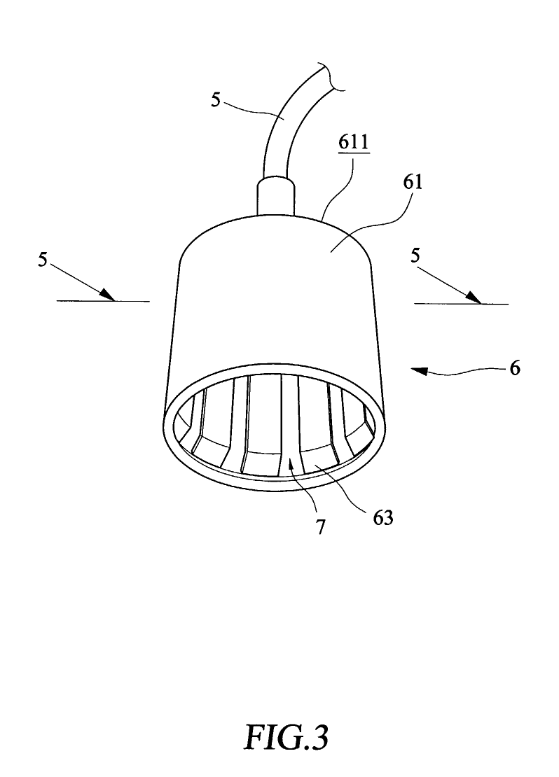

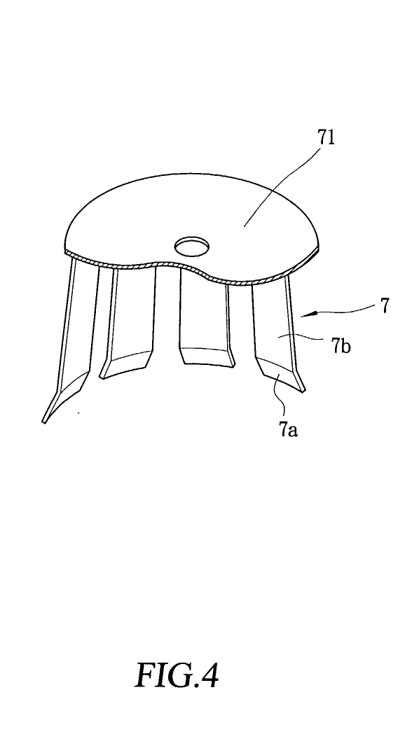

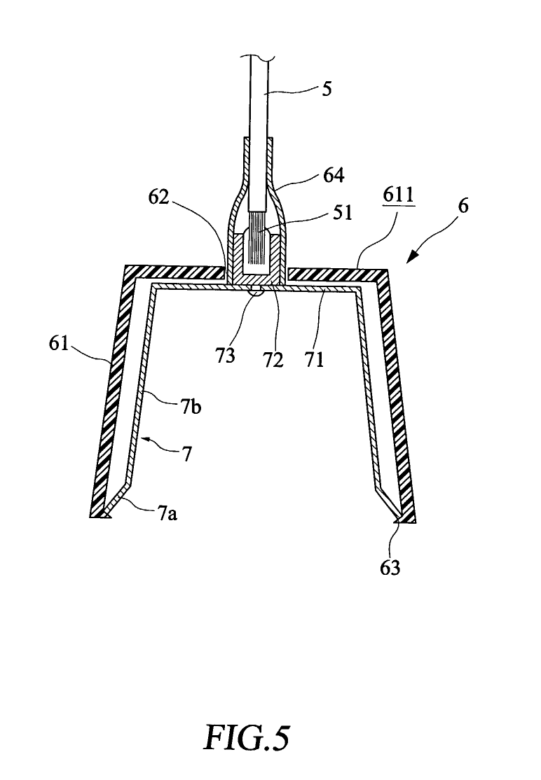

FIG. 3 is a bottom perspective view showing that the quick coupler 6 of the present invention includes an insulated mask 61 having a top plate 611 and downward cylindrical wall integrally formed from the top plate 611. With reference to FIGS. 4 and 5, the insulated mask 61 forms an internal cavity and is tapered with a broad open bottom end adapted to mount onto a cylindrical battery terminal of the battery. The top plate 611 is provided with a central through hole 62. Moreover, the quick coupler 6 includes a metal disk 71 and a plurality of elastic metal strips 7 mounted in the internal cavity of the insulted mask 61. As shown in FIG. 4, the elastic metal strips 7 are extended from a periphery of the metal disk 71. Each of the elastic metal strips 7 is formed with a terminal contact section 7b and an inclined section 7a integrally extended from the terminal contact section 7b.

With reference to FIG. 5, preferably, the terminal contact section 7b is extended downward from the metal disk 71, and is adjacent to the interior surface of the cylindrical wall of the insulated mask 61. The inclined section 7a is slightly extended outward from the terminal contact section 7b and is engaged with an inward edge 63 formed on the bottom edge of the cylindrical wall of the insulated mask 61. By this way, the elastic metal strip 7 is firmly mounted within the insulated mask 61.

As shown in FIG. 5, the metal disk 71 is fixed with an upward wire connection portion 72 protrusive to the central through hole 62 of the insulated mask 61 by means of a fastening element 73. The wire connection portion 72 of the metal disk 71 is connected with a tip end 51 of the electric wire 5. Besides, the wire connection portion 72 is preferably covered with an insulated sleeve 64 for electric insulation. The wire connection portion 72 is conductive and connects the power from the electric wire 5 to the metal disk 71.

The quick coupler 6 can be tightly connected to a cylindrical terminal of a battery by mounting the insulated mask 61 on the cylindrical terminal. At this time, each elastic metal strip 7 contacts the conductive surface of the cylindrical terminal of the battery, and the top end of the cylindrical terminal of the battery tightly touches the bottom surface of the metal disk 71, resulting a good electrical contact.

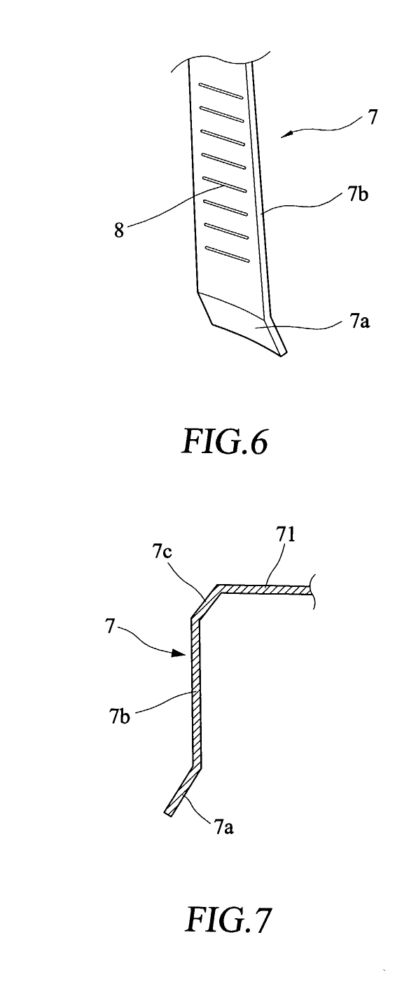

With reference to FIG. 6, it is a partially enlarged perspective view showing the elastic metal strip 7 of the present invention. As shown in the drawing, the interior surface of the elastic metal strip 7 at its terminal contact section 7b is preferably formed with a plurality of transverse ribs 8. When the quick coupler 6 mounts onto the cylindrical terminal of the battery, the elastic metal strip 7 may further tightly contact the exterior surface of the cylindrical terminal of the battery by means of the transverse ribs 8 with better electrical contact therebetween.

FIG. 7 is an enlarged cross-sectional view further showing that the elastic metal strip 7 is formed with a bent section 7c between the metal disk 71 and the terminal contact section 7b.

Although the present invention has been described with respect to the preferred embodiments, it is contemplated that a variety of modifications, variations and substitutions may be done without departing from the scope of the present invention that is intended to be defined by the appended claims.

What is claimed is:

1. A quick coupler with an electric wire for connecting a cylindrical terminal of a battery comprising:
an insulated mask, which is formed a top plate and a downward cylindrical wall extended from the top plate and has a bottom open end, forming an internal cavity, the top plate further having a central through hole;
a metal disk fixed on a bottom surface of the top plate of the insulated mask;
a plurality of elastic metal strips, each of which is spaced from each other and extended downward from the metal disk, the elastic metal strips being adjacent to an interior surface of the cylindrical wall of the insulated mask; and
a wire connection portion formed on the metal disk and protruded to the central through hole of the insulated mask for electrically connecting the electric wire;
when the insulated mask is mounted on the cylindrical terminal of the battery, the elastic metal strips contact the cylindrical terminal of the battery and the metal disk contacts an top end of the cylindrical terminal.

2. The quick coupler as claimed in claim 1, wherein the insulated mask is tapered in shape, having a smaller diameter at the top plate and a larger diameter at the bottom open end.

3. The quick coupler as claimed in claim 1, wherein the insulated mask is further formed with an inward edge at the interior surface adjacent to open end of the cylindrical wall, for firmly engaging the elastic metal strips to the insulated mask.

4. The quick coupler as claimed in claim 1, wherein each elastic metal strip comprises:
a terminal contact section downwardly extended from the metal disk; and
an outward inclined section extended from a bottom end of the terminal contact section.

5. The quick coupler as claimed in claim 1, wherein each elastic metal strip comprises:
a bent section extended from the metal disk;
a terminal contact section downwardly extended from an end of the bent section in corresponding to the end connecting to the metal disk; and
an outward inclined section extended from a bottom end of the terminal contact section.

6. The quick coupler as claimed in claim 1, further comprising an insulated sleeve covering on the wire connection portion.

7. The quick coupler as claimed in claim 1, wherein each of the elastic metal strip is further formed with a plurality of transverse ribs on its interior surface wall.
